(19) United States
(12) Patent Application Publication
(10) Pub. No.: US 2021/0253157 A1
(43) Pub. Date: Aug. 19, 2021

(54) STEER-BY-WIRE ARCHITECTURES HAVING A SECOND STEERING ANGLE SENSOR

(71) Applicants: thyssenkrupp Presta AG, Eschen (LI); thyssenkrupp AG, Essen (DE)

(72) Inventors: Botond HAMORI, Budapest (HU); Zoltan GAAL, Budapest (HU); Peter KAKAS, Budapest (HU)

(73) Assignees: thyssenkrupp Presta AG, Eschen (LI); thyssenkrupp AG, Essen (DE)

(21) Appl. No.: 17/252,470

(22) PCT Filed: Jun. 18, 2019
(86) PCT No.: PCT/EP2019/065956

§ 371 Date: Dec. 15, 2020

(30) Foreign Application Priority Data
Jun. 21, 2018 (DE) 10 2018 114 988.3

(51) Int. Cl. B62D 5/00; B62D 5/04; B62D 15/02

(52) U.S. Cl. CPC B62D 5/003; B62D 5/006; B62D 15/021; B62D 5/0484

(57) ABSTRACT

A steer-by-wire steering system for motor vehicles, including a steering actuator electronically controlled depending on a driver's steering command and acting on the steered wheels and a feedback actuator transmitting feedback from the road to a steering wheel and further including a first steering angle sensor. The steering actuator includes a redundant power supply and is connected to a first power supply and a second power supply. The feedback actuator is connected to the first power supply and the steer-by-wire steering system includes a second steering angle sensor, which is independent of the feedback actuator and is connected to the second power supply.

The present invention relates to a steer-by-wire steering system for motor vehicles having the features of the definition of the species in claim 1.

In steer-by-wire steering systems, the position of the steered wheels is not directly coupled to the steering wheel. There is a connection between the steering wheel and the steered wheels via electrical signals. A steering actuator for positioning the wheels as well as a feedback actuator for simulating the restoring forces at the steering wheel are utilized in place of the mechanical coupling. In order to meet the safety requirements, the steering system must be designed in such a way that the functionality is maintained. Mainly due to the costs incurred, a suitable compromise must be found here between the degree of the error tolerance and the number of redundant components.

The problem addressed by the present invention is that of providing a steer-by-wire steering system for motor vehicles, which is cost-effective and consistently operates in a reliable manner, in order to meet the safety objectives.

This problem is solved by a steer-by-wire steering system having the features of claim 1. Advantageous refinements of the invention are described in the dependent claims.

Accordingly, a steer-by-wire steering system for motor vehicles is provided, comprising a steering actuator electronically controlled depending on a driver's steering command and acting on the steered wheels, and a feedback actuator transmitting feedback from the road to a steering wheel and comprising a first steering angle sensor, wherein the steering actuator comprises a redundant power supply and is connected to a first power supply and a second power supply, wherein the feedback actuator is connected to the first power supply and the steer-by-wire steering system comprises a second steering angle sensor, which is independent of the feedback actuator and is connected to the second power supply.

Due to the second external steering angle sensor, there is the possibility to cost-effectively utilize an actuator (column EPS), which is provided for an electromechanical motor vehicle steering system for the positioning at the steering train, as a feedback actuator in a steer-by-wire steering system and nevertheless achieve the necessary safety objectives of a steer-by-wire steering system. The feedback actuator is preferably exclusively connected to the first power supply.

Preferably, the two power supplies are designed in such a way that, in the event of a failure of one of the two power supplies, the particular other power supply ensures that the steering actuator can continue to be operated. It is advantageous when the steer-by-wire steering system comprises a private communication channel, via which the feedback actuator communicates with the steering actuator. In one embodiment it is provided that the steer-by-wire steering system comprises a single motor vehicle communication channel, via which the feedback actuator communicates with the motor vehicle as well as with the steering actuator. In the event of failure of one of the communication channels (private communication channel, motor vehicle communication channel), the particular other, fault-free channel can take over the necessary communication between the feedback actuator and the steering actuator. The communication is therefore redundantly designed. It is preferably provided that the steer-by-wire steering system comprises a direct communication channel between the second steering angle sensor and the steering actuator, via which the second steering angle sensor can transmit the measured steering angle to the steering actuator. In the event of a failure of the feedback actuator, the system accesses the second steering angle sensor, which communicates with the steering actuator independently of the feedback actuator and, therefore, provides for a proper function of the steering system.

In a second embodiment, the steer-by-wire steering system can comprise a single motor vehicle communication channel, via which the steering actuator communicates with the motor vehicle as well as with the second steering angle sensor. A communication with the feedback actuator via the motor vehicle communication channel does not take place. In the event of a failure of the feedback actuator, the system accesses the second steering angle sensor, which communicates with the steering actuator independently of the feedback actuator via the motor vehicle communication channel and, therefore, provides for a proper function of the steering system.

As explained above, the feedback actuator is preferably formed by an actuator for an electromechanical steering system. Existing components of an electromechanical steering system can therefore be installed into the steer-by-wire system, whereby costs can be saved.

Preferably, the second steering angle sensor is mounted externally at the feedback actuator.

Preferred embodiments of the invention are explained in greater detail in the following with reference to the drawings. Identical or identically acting components are labeled in the figures with the same reference numbers. Wherein:

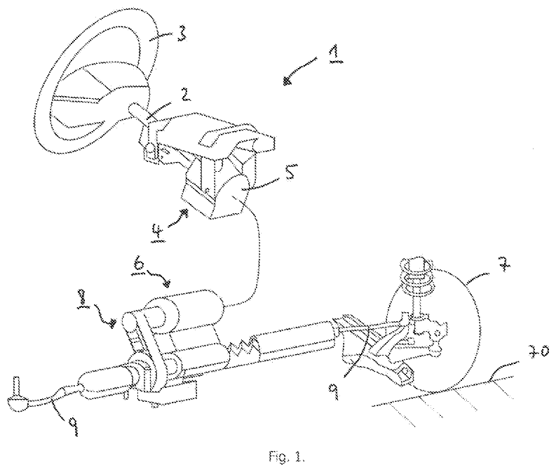

FIG. 1 shows a schematic representation of a steer-by-wire steering system,

FIG. 2 shows a block diagram of an architecture of the steer-by-wire steering system, and

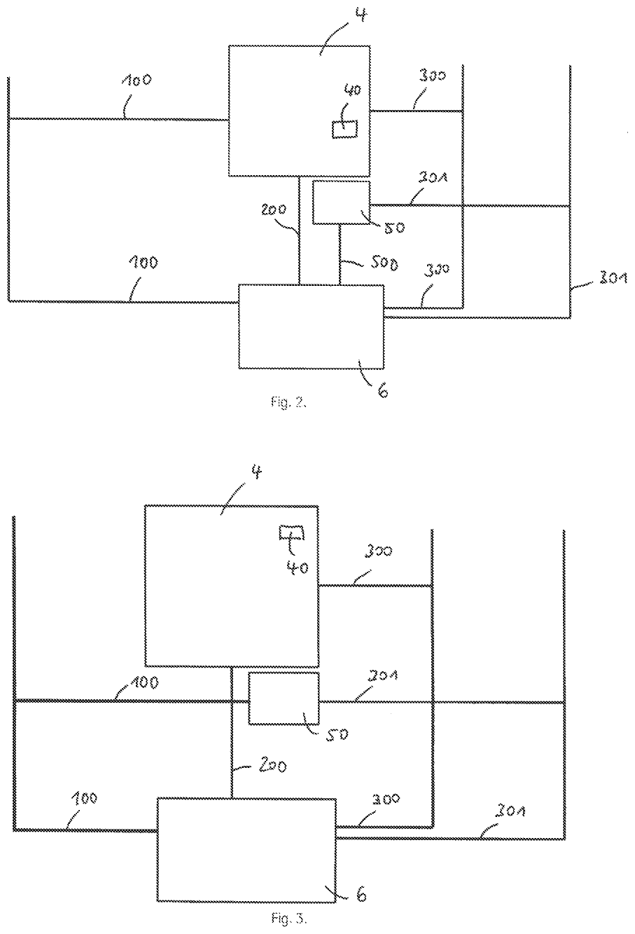

FIG. 3 shows a block diagram of a second architecture of the steer-by-wire steering system.

In FIG. 1, a steer-by-wire steering system 1 is shown. An angle-of-rotation sensor (not represented) is mounted at a steering shaft 2, which detects the driver's steering torque applied by turning the steering wheel 3. Moreover, a feedback actuator 4 is mounted at the steering shaft 2, which is utilized for transmitting the feedback from the roadway 70 onto the steering wheel 3 and, therefore, providing the driver with feedback regarding the steering and driving behavior of the vehicle. The driver's steering command is transmitted via the rotation angle of the steering shaft 2 measured by the steering angle sensor to a control unit 5 with the aid of signal lines. Depending on the signal from the angle-of-rotation sensor as well as further input variables, such as vehicle speed, yaw rate, and the like, the control unit 5 activates an electrical steering actuator 6, which controls the position of the steered wheels 7. The steering actuator 6 effectuates an axial displacement of a toothed bar with the aid of a threaded drive 8. The steered wheels 7 are connected to the toothed bar via steering links 9.

FIG. 2 shows a first embodiment of a wiring architecture for a steer-by-wire steering system. The feedback actuator 4 and the steering actuator 6 communicate via a common motor vehicle communication channel 100 with the motor vehicle and with one another. The feedback actuator 4 communicates on a private communication channel 200 with the steering actuator 6. In the event of a failure of one of the two communication channels (motor vehicle communication channel 100, private communication channel 200), the steering system continues to function properly, since all necessary signals are transmitted via both channels 100, 200.

A redundant power supply for the steering actuator 6 is provided. The feedback actuator 4 and the steering actuator 6 are both connected to a first power supply 300. The steering actuator is also connected to a second power supply 301. In the event of a failure of one of the two power supplies 300, 301 or in the event of another electronic fault (for example, short circuit, software error), the other, fault-free power supply 300, 301 ensures that the steering actuator 6 can continue to be operated. The feedback actuator 4 comprises an integrated steering angle sensor 40 (SAS), which is supplied with current via the power supply of the feedback actuator. An additional second steering angle sensor 50, which is mounted externally at the feedback actuator 4, is connected to the second power supply 301. If the first power supply 300 and, therefore, the feedback actuator 4 comprising the integrated steering angle sensor 40 fail, the second, independent steering angle sensor 50 takes over the measurement of the angular position of the steering shaft and, therefore, of the driver's steering command. The second steering angle sensor 50 has a direct connection 500 to the steering actuator 6, in order to be able to forward the measured rotation angle to the steering actuator 6 in order to control the steer-by-wire steering system.

FIG. 3 shows a second embodiment of a wiring architecture for a steer-by-wire steering system. In this case as well, the steering actuator 6 is a redundant fail-operational system, i.e., in the presence of faults in the system, a defined degree of operability can be maintained. The steering actuator 6 communicates with the motor vehicle via a motor vehicle communication channel 100. The feedback actuator 4 communicates on a private communication channel 200 with the steering actuator 6. In the event of a failure of one of the two communication channels (motor vehicle communication channel 100, private communication channel 200), the steering system continues to function properly, since all necessary signals are transmitted via both channels.

A redundant power supply for the steering actuator 6 is provided. The feedback actuator 4 and the steering actuator 6 are both connected to a first power supply 300. The steering actuator is also connected to a second power supply 301. In the event of a failure of one of the two power supplies 300, 301, the other, fault-free power supply 300, 301 ensures that the steering actuator 6 can continue to be operated. The feedback actuator 4 comprises an integrated steering angle sensor 40 (SAS). An additional second steering angle sensor 50, which is mounted externally at the feedback actuator 4, is connected to the second power supply 301. If the first power supply 300 and, therefore, the feedback actuator fail, the second, independent steering angle sensor 50 takes over the measurement of the angular position of the steering shaft and, therefore, of the driver's steering command. The second steering angle sensor 50 is connected to the steering actuator 6 via the motor vehicle communication channel 100 for this case.

In both embodiments, the feedback actuator is preferably formed by an actuator of an electromechanical steering system, in particular by an actuator, which is provided for power assistance at the steering train column EPS).

1.-8. (canceled)

9. A steer-by-wire steering system for motor vehicles, comprising:
a steering actuator electronically controlled based on steering command and configured to act on the steered wheels, and
a feedback actuator configured to transmit feedback from a road to a steering wheel of the motor vehicle, and
a first steering angle sensor,
wherein the steering actuator comprises and is connected to a redundant power supply comprising a first power supply and a second power supply,
wherein the feedback actuator is connected to the first power supply, and
a second steering angle sensor, which is independent of the feedback actuator and is connected to the second power supply.

10. The steer-by-wire steering system of claim 9 wherein the first and second power supplies are designed such that, in the event of a failure of one of the two power supplies, the other power supply supplies power to the steering actuator.

11. The steer-by-wire steering system of claim 9 wherein the steer-by-wire steering system comprises a private communication channel, via which the feedback actuator communicates with the steering actuator.

12. The steer-by-wire steering system of claim 9 wherein the steer-by-wire steering system comprises a single motor vehicle communication channel, via which the feedback actuator communicates with the motor vehicle as well as with the steering actuator.

13. The steer-by-wire steering system of claim 12 wherein the steer-by-wire steering system comprises a direct communication channel between the second steering angle sensor and the steering actuator, via which the second steering angle sensor transmits the measured steering angle to the steering actuator.

14. The steer-by-wire steering system of claim 9 wherein the steer-by-wire steering system comprises a single motor vehicle communication channel, via which the steering actuator communicates with the motor vehicle as well as with the second steering angle sensor.

15. The steer-by-wire steering system of claim 9 wherein the feedback actuator an actuator for an electromechanical steering system.

16. The steer-by-wire steering system of claim 9 wherein the second steering angle sensor is mounted externally at the feedback actuator.
